(19) United States
(12) Patent Application Publication
(10) Pub. No.: US 2006/0051212 A1
(43) Pub. Date: Mar. 9, 2006

(54) Coated turbine blade, turbine wheel with plurality of coated turbine blades, and process of coating turbine blade

(76) Inventors: Timothy O'Brien, Chandler, AZ (US); William Weidner, Mesa, AZ (US); Robert Hundertmark, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/935,087

(22) Filed: Sep. 8, 2004

(51) Int. Cl. F03B 3/12

(52) U.S. Cl. 416/241 R

(57) ABSTRACT

A turbine blade includes a platform having a top surface, a bottom surface, and a peripheral sidewall between the top and bottom surfaces. An airfoil protrudes from the top surface of the platform. A blade mount extends from the bottom surface of the platform for attaching the turbine blade to a turbine wheel. A corrosion resistant protective coating is applied on one or more of the airfoil, the top surface, the peripheral sidewall and the bottom surface of the platform.

### BACKGROUND OF THE INVENTION

1. Field of the Invention

The present invention relates generally to a coated turbine blade and to a process of coating the turbine blade. More particularly, the present invention is directed to a coated turbine blade that forms part of a turbine wheel assembly that is used, for example, in an auxiliary power unit of an aircraft, and a process for coating such a turbine blade. It will be appreciated, however, that while turbine blades will be disclosed for use in auxiliary power units, they are not limited to such an application.

2. Description of Related Background Art

An auxiliary power unit (APU) provides the primary source of power in an aircraft when it is on the ground. An APU may also provide an auxiliary source of power to an aircraft when it is in the air.

A critical component of an APU is a turbine wheel assembly. As shown in FIG. 1, the turbine wheel assembly 10 includes a disc 12 and a plurality of turbine blades 14 mounted to the periphery of the disc. In this non-limiting example, the disc is approximately 8-10 inches in diameter, has 36 turbine blades mounted thereto, and can operate at a speed of up to about 52,000 rpm. During operation, the turbine blades can experience temperatures on the order of 2000 degrees F.

Until recently, the life span of a typical APU was relatively short, for example, providing 2000 hours of running time. After this time, which may give the APU a life span of a year or so depending on how frequently the airplane is in use, the APU was typically overhauled (replacing parts, such as the turbine wheel assembly, as opposed to servicing and maintaining them).

In a conventional turbine blade for use in an APU as discussed above, a portion of the turbine blade is coated with a corrosion resistant material. For example, and with reference to FIG. 2, an airfoil 22 and a top surface 32 of a platform 24 of the blade have conventionally been coated with a metallic corrosion--resistant protective coating, such as, for example, CoCrAlY.

Due to recent advancements in design and technology, APU's with a life span of 8,000 to 10,000 hours operating time or even more are now available. With these longer lasting APU's, however, it has been found that conventional turbine blades are unable to provide a satisfactory service life. Specifically, areas of the turbine blade that are not treated with a corrosion resistant material are prone to fatigue failure propagated by stress concentrations (e.g., pitting, scaling, cracking, etc.) caused by hot corrosion, sulfidation, and the like, after prolonged exposure to elevated temperatures, pollutants, particulates and corrosive dust.

One attempt to address this problem has been to treat the bottom surface of the platform with an aluminide coating applied by a diffusion process, such as a pack cementation process or a chemical vapor deposition (CVD) process. In the pack cementation process, the parts or areas to be coated are packed in an aluminum-rich powder. Heat is then applied to diffuse the aluminide into the coated part. This aluminide coating process has found some use in coating the underside of the platform of turbine blades. There are limitations, however, in both the aluminide coating itself and the coating process, that leave room for improvement.

Accordingly, there is a need for providing a turbine blade with an improved corrosion-resistant protective coating and a process for applying such a coating.

### SUMMARY OF THE INVENTION

A general object of the present invention is to provide an improved turbine blade.

Another object of the invention is to provide a turbine blade with a coating to reduce or even prevent corrosion, and an improved process for coating the turbine blade.

In accordance with one aspect of the invention, a turbine blade comprises a platform having a top surface, a bottom surface, and a peripheral sidewall between the top and bottom surfaces. An airfoil protrudes from the top surface of the platform. A blade mount extends from the bottom surface of the platform for attaching the turbine blade to a turbine wheel. A corrosion resistant protective coating of MCrAlY is applied on the airfoil, the top surface, the peripheral sidewall and the bottom surface of the platform.

In accordance with another aspect of the invention, a turbine blade comprises a platform having a top surface, a bottom surface, and a peripheral sidewall between the top and bottom surfaces. An airfoil protrudes from the top surface of the platform. A blade mount extends from the bottom surface of the platform for attaching the turbine blade to a turbine wheel. A corrosion resistant protective coating of MCrAlY is applied on the bottom surface of the platform.

In accordance with still another aspect of the invention, a turbine blade comprises a platform having a top surface, a bottom surface, and a peripheral sidewall between the top and bottom surfaces. An airfoil protrudes from the top surface of the platform. A blade mount extends from the bottom surface of the platform for attaching the turbine blade to a turbine wheel. A corrosion resistant protective coating of MCrAlY is applied on the airfoil, the top surface, and the peripheral sidewall of the platform.

In accordance with another aspect of the invention, a distance from a top edge of the airfoil to a bottom edge of the blade mount is about two inches or less, and a distance between the bottom surface of the platform to the blade mount is about ½ inch or less.

Also, the protective covering preferably coats the airfoil, the top surface, the peripheral sidewall and recesses in the bottom surface of the platform in their entirety.

Preferably, the protective coating covering the bottom surface of the platform is applied using a high-velocity oxygenated fuel (HVOF) process, and the protective coating covering the airfoil, the top surface, and the peripheral sidewall of the platform is applied using an electron beam physical vapor deposition (EBPVD) process.

In accordance with another aspect of the invention, there is a method of coating a turbine blade comprising a platform, including a top surface, a bottom surface, and a peripheral sidewall, an airfoil protruding from the top surface of the platform, and a blade mount extending from the bottom surface of the platform, for attaching the turbine blade to a turbine wheel. The method comprises the steps of applying a first corrosion-resistant protective coating of MCrAlY to the bottom surface of the platform, and applying a second corrosion-resistant protective coating of MCrAlY to the airfoil, the top surface, and the peripheral sidewall of the platform.

Preferably, the method includes one or more of the additional steps of using the same compound as the first protective coating and the second protective coating, using CoCrAlY as the first and second protective coatings, and applying the second protective coating after the first protective coating is applied.

The method preferably also includes the step of masking off portions of the turbine blade except for the bottom surface of the platform, and applying the first protective coating using a high-velocity oxygenated fuel process, and/or the step of masking off portions of the turbine blade except for the airfoil, the top surface of the platform and the peripheral sidewall, and applying the second protective coating using an electron beam physical vapor deposition process.

In accordance with yet another aspect of the invention, a turbine wheel assembly comprises a rotatable disc having an outer periphery, and a plurality of turbine blades affixed to the disc at the outer periphery. Each of the turbine blades comprises a platform having a top surface, a bottom surface and at least one peripheral sidewall. An airfoil protrudes from the top surface of the platform. A blade mount extends from the bottom surface of the platform for attaching the turbine blade to the disc. A corrosion resistant protective coating of MCrAlY is applied on one or more of the airfoil, the top surface, the peripheral sidewall and the bottom surface of the platform.

A better understanding of these and other objects, features, and advantages of the invention may be had by reference to the drawings and to the accompanying description, in which preferred embodiments of the invention are illustrated and described.

### BRIEF DESCRIPTION OF THE DRAWINGS

FIG. 1 illustrates a turbine wheel assembly.

FIG. 2 is an isometric view of a turbine blade according to a preferred embodiment of the invention.

FIG. 3 illustrates a top plan view of the turbine blade of FIG. 2.

FIG. 4 illustrates a side elevation view of the turbine blade of FIG. 2, taken along line 4-4.

FIG. 5 is a rear elevation view of the turbine blade of FIG. 2, taken along line 5-5.

### BEST MODE FOR CARRYING OUT THE INVENTION

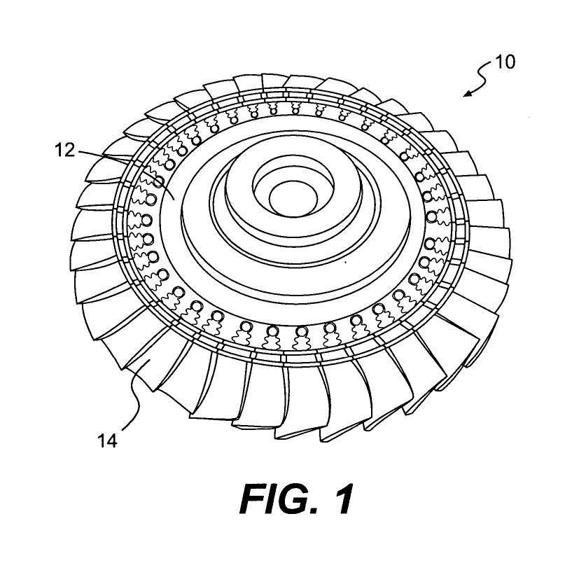

FIG. 1 illustrates a turbine wheel assembly 10, including a disc 12 with a plurality of turbine blades 14 attached around its periphery. The invention relates generally to a turbine blade at least partially covered with a corrosion resistant protective coating, and a method of coating a turbine blade with such a corrosion resistant material. Turbine blades according to the invention can be mounted on a conventional turbine wheel assembly, such as the one shown in FIG. 1. The turbine wheel assembly 10 illustrated in FIG. 1 is designed for use in an APU, as described above, but is not limited to such use.

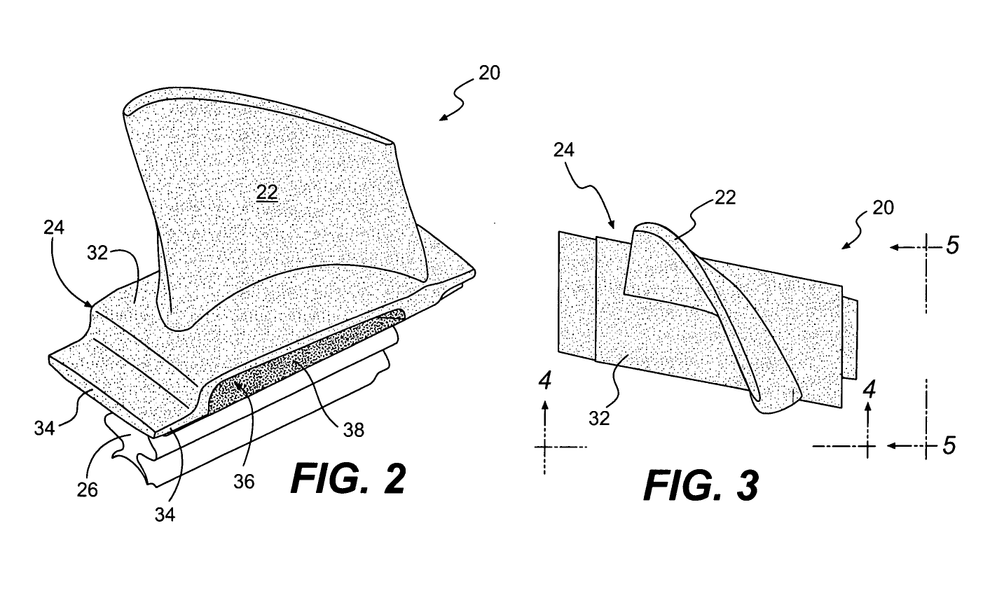

A turbine blade 20 according to a preferred embodiment of the invention is illustrated in FIG. 2. The turbine blade comprises a platform 24 having a top surface 32, a bottom surface 36, and a peripheral sidewall 34 between the top and bottom surfaces. The peripheral sidewall extends around the entire circumference of the platform. An airfoil 22 protrudes from the top surface 32 of the platform 24. The largest dimension of the turbine blade shown in FIGS. 2-5, i.e., the overall height b of the turbine blade from the top of the air foil to the bottom of the blade mount, is preferably about two inches. A blade mount 26 extends from the bottom surface 36 of the platform 24 for attaching the turbine blade to the disc of a turbine wheel assembly.

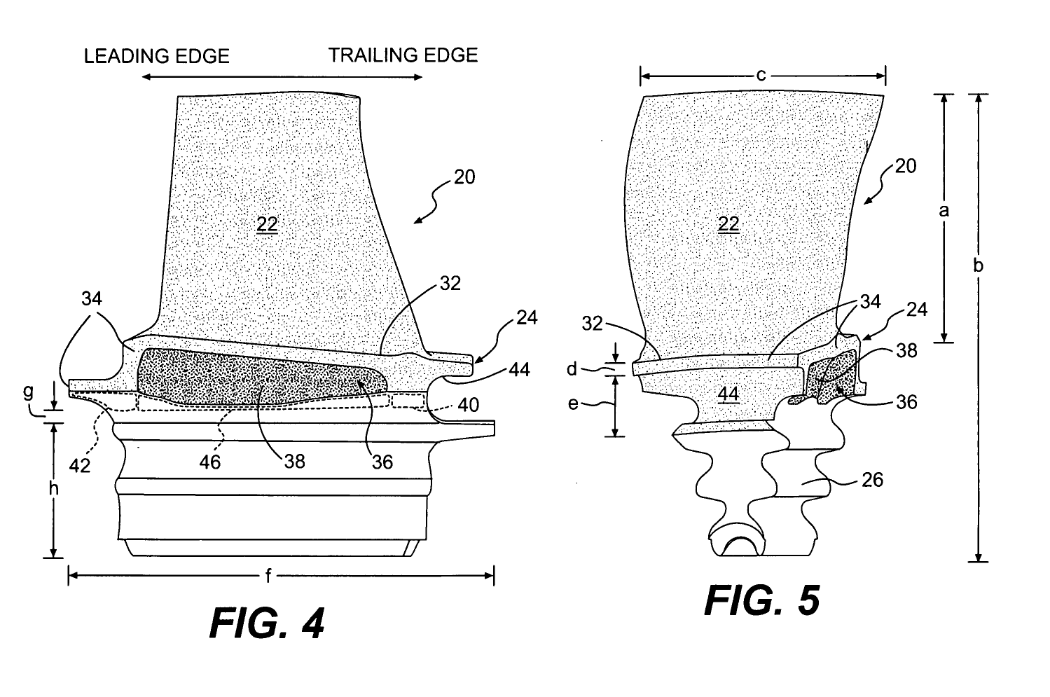

By way of example only, and with reference to FIGS. 4 and 5, in one particularly preferred embodiment, the overall height b of the turbine blade is about 1.32 inches and the overall width f of the turbine blade is about 1.25 inches. In this example, height a of the airfoil is about 0.69 inches and the width c of the airfoil at its upper most edge is about 0.71 inches. Preferably, the platform has a sidewall thickness d of about 0.05 inches and the bottom surface of the platform extends a distance e of about 0.24 inches.

The turbine blade is preferably a unitary body formed, for example, by investment casting, and is preferably made from a Nickle alloy; more preferably, the turbine blade is fabricated by an Equiaxed casting of MAR-M 247 Nickle alloy. Of course, other methods of forming the turbine blade (as either a unitary or composite body), and alternative materials, can be used without departing from the scope of the invention.

In the embodiment shown in FIGS. 2-5, the blade mount 26 has a tapered, serrated profile, commonly known in the industry as a “fir tree.” As an example, the blade mount shown in the figures preferably has a height h of about 0.38 inches. However, any other size, shape, and/or configuration of blade mount may be used, as long as it is sufficient, either alone or in combination with other elements, to secure the turbine blade to the disc of the turbine wheel assembly.

As best shown in FIGS. 4 and 5, the bottom surface 36 of the platform 24 includes a pair of pockets 38, which are elongated recesses formed on opposite sides of the bottom surface as it extends toward the blade mount 26. As will be appreciated, not all turbine blades need to have pockets, such as those depicted in FIGS. 4 and 5. Rather, the bottom surface of the platform may have any suitable configuration (with or without pockets) between the platform 24 and the blade mount 26. It is important to note, however, that it is these surfaces—the surfaces below the top of the platform and above the blade mount that are coated in accordance with one aspect of the invention.

A corrosion resistant protective coating is applied to portions of the turbine blade 20 to help prevent, among other things, stress concentrations caused by corrosion (that could potentially lead to crack propagation and ultimately fatigue failures of the turbine blades). Preferably, the corrosion resistant protective coating comprises a metallic compound, such as an MCrAlY alloy (of e.g., CoCrAlY or NiCoCrAlY). Preferably, the corrosion resistant coating comprises a CoCrAlY alloy coating. CoCrAlY alloy provides excellent corrosion resistance (per mil of coating thickness), can be effectively applied at optimum thicknesses, such as about 2 to about 6 mils, and exhibits good ductile characteristics. Finally, the CoCrAlY coating can be applied (at least in part) by an HVOF process, which has been found to be very effective in coating relatively small scale turbine blades like those shown in FIGS. 2-5.

Other metallic CrAlY (MCrAlY) alloys, such as NiCrAlY could also be used in situations where resistance to oxidation is important.

While it is preferable to use a single type of corrosion resistant protective coating on the turbine blade, two or more different corrosion resistant protective coatings may be used to coat the same or different parts of a turbine blade, depending on the particular application and the environment in which it is intended to be used.

The corrosion resistant protective coating may be applied to one or more of the airfoil 22, the top surface 32 of the platform 24, the peripheral sidewall 34 of the platform 24, and the bottom surface 36 of the platform 24. The corrosion resistant protective coating may be applied to these elements in whole or in part, depending on the particular needs of the application. Preferably, however, the corrosion resistant protective coating is applied to the airfoil 22, the top surface 32 of the platform 24, and the peripheral sidewall 34 of the platform 24 in their entirety. The corrosion resistant protective coating is preferably applied to a substantial portion of the bottom surface 36 of the platform 24, but not to the bottom surface 36 in an area adjacent to the blade mount 26. Preferably, a distance g between the bottom of the coated area and the top of the blade mount is preferably at most ½ inch. In one particularly preferred embodiment shown in FIGS. 4 and 5, the distance g between the bottom surface of the coated area and the top of the blade mount is about 0.04 inches. The preferred area of protective coating on the bottom surface is described in more detail below. The corrosion resistant protective coating is preferably not applied to the blade mount 26 of the turbine blade.

The corrosion resistant protective coating may be applied by any suitable application process. In one preferred embodiment, the corrosion resistant protective coating is applied using an HVOF process in combination with an EBPVD process. Both of these general processes are, per se, known in the art. Preferably, a corrosion resistant protective coating is applied to the bottom surface 36 of the platform 24 by an HVOF process, while a corrosion resistant protective coating is applied to the airfoil 22, the upper surface 32 of the platform 24, and the peripheral sidewall 34 of the platform 24 by an EBPVD process. In a particularly preferred embodiment, the corrosion resistant protective coatings applied by both the HVOF and EBPVD processes are CoCrAlY alloy coatings. When HVOF and EBPVD processes are used to coat different portions of a turbine blade with the corrosion resistant protective coating, it is preferable that the HVOF process be performed prior to the EBPVD process.

In the embodiment depicted in FIGS. 4 and 5, application of the corrosion resistant protective coating to the bottom surface 36 (using an HVOF process) is preferably applied to the pockets 38. The corrosion resistant protective coating may also be applied by HVOF and/or EBPVD processes to the areas directly adjacent to the pockets 38, including an underside of the leading edge 42 of the platform, an underside of the trailing edge 40 of the platform, and a central region 46 between the pockets 38 and the blade mount 26. Also, the corrosion resistant protective coating may be applied to an undersurface of a trailing flange 44.

In one preferred method of coating a turbine blade in accordance with the subject invention, the surfaces of the turbine blade 20 are masked off, except for the bottom surface 36 of the platform 24. Then, a first corrosion resistant protective coating is applied using an HVOF process. After the masks are removed, any over-spray from the HVOF process on the airfoil 22, top surface 32 of the platform 34, or the peripheral sidewall 34 of the platform is preferably removed by hand polishing, or the like. Next, the surfaces of the turbine blade 20 are masked off, except for the airfoil 22, the top surface 32 of the platform 24, and the peripheral sidewall 34 of the platform 24. Then a second corrosion resistant protective coating is applied using a EBPVD process. Preferably, both the first and second protective coatings are the same; more preferably, both are CoCrAlY alloy coatings.

Various other processes, including cleaning of the turbine blade, shot peening of the coated surfaces, and the like may be performed on the turbine blade, as necessary or desirable for a given application and/or to achieve a desired finish.

While the turbine blade 20 depicted in FIGS. 2-5 is a preferred embodiment of the invention, the size, shape, and configuration of the turbine blade and its component parts (e.g., airfoil, platform, blade mount, etc.) may vary depending on the type of application (e.g., aircraft engine, aircraft auxiliary power unit, industrial auxiliary power unit), the operating conditions (e.g., humidity, temperature, corrosive environment, etc.), the desired operating life, and numerous other design considerations.

The embodiments discussed herein are representative of preferred embodiments of the invention and are provided for illustrative purposes only. They are not intended to limit the scope of the invention. Although specific structures, dimensions, components, methods, etc., have been shown and described, such are not limiting. Modifications and variations are contemplated within the scope of my invention, which is intended to be limited only by the scope of the accompanying claims.

We claim:

1. A turbine blade comprising:
a platform having a top surface, a bottom surface, and a peripheral sidewall between said top and bottom surfaces;
an airfoil protruding from said top surface of said platform;
a blade mount extending from said bottom surface of said platform for attaching the turbine blade to a turbine wheel; and
a corrosion resistant protective coating of MCrAlY on said airfoil, said top surface, said peripheral sidewall and said bottom surface of said platform.

2. A turbine blade according to claim 1, wherein said protective coating is CoCrAlY.

3. A turbine blade according to claim 1, wherein a distance from a top edge of said airfoil to a bottom edge of said blade mount is at most two inches.

4. A turbine blade according to claim 1, wherein a distance from said bottom surface of said platform to said blade mount is at most ½ inch.

5. A turbine blade according to claim 1, with said protective coating covering said airfoil, said top surface, and said peripheral surface of said platform in their entirety, and recesses in said bottom surface are also coated in their entirety.

6. A turbine blade according to claim 5, wherein said protective coating covering said bottom surface of said platform having been applied using a high-velocity oxygenated fuel process.

7. A turbine blade according to claim 5, wherein said protective coating covering said airfoil, said top surface, and said peripheral sidewall of said platform having been applied using an electron beam vapor physical vapor deposition process.

8. A turbine blade comprising:
a platform having a top surface, a bottom surface, and a peripheral sidewall between said top and bottom surfaces;
an airfoil protruding from said top surface of said platform;
a blade mount extending from said bottom surface of said platform for attaching the turbine blade to a turbine wheel; and
a corrosion resistant protective coating of MCrAlY on said airfoil, said top surface, and said peripheral sidewall of said platform.

9. A turbine blade according to claim 8, wherein said protective coating is CoCrAlY.

10. A turbine blade according to claim 8, wherein a distance from a top edge of said airfoil to a bottom edge of said blade mount is at most two inches.

11. A turbine blade according to claim 8, wherein a distance from said bottom surface of said platform to said blade mount is at most ½ inch.

12. A turbine blade according to claim 7, with said protective coating covering said airfoil, said top surface, and said peripheral sidewall of said platform in their entirety.

13. A turbine blade according to claim 11, wherein said protective coating covering said airfoil, said top surface, and said peripheral sidewall of said platform having been applied using an electron beam vapor physical vapor deposition process.

14. A turbine blade comprising:
a platform having a top surface, a bottom surface, and a peripheral sidewall between said top and bottom surfaces;
an airfoil protruding from said top surface of said platform;
a blade mount extending from said bottom surface of said platform for attaching the turbine blade to a turbine wheel; and
a corrosion resistant protective coating of MCrAlY on said bottom surface of said platform.

15. A turbine blade according to claim 14, wherein said protective coating is CoCrAlY.

16. A turbine blade according to claim 14, wherein a distance from a top edge of said airfoil to a bottom edge of said blade mount is at most two inches.

17. A turbine blade according to claim 14, wherein a distance from said bottom surface of said platform to said blade mount is at most ½ inch.

18. A turbine blade according to claim 14, with said protective coating covering recesses in said bottom surface of said platform in their entirety.

19. A turbine blade according to claim 18, wherein said protective coating covering said bottom surface of said platform having been applied using a high-velocity oxygenated fuel process.

20. A method of coating a turbine blade comprising a platform, including a top surface, a bottom surface, and a peripheral sidewall, an airfoil protruding from the top surface of the platform, and a blade mount extending from the bottom surface of the platform, for attaching the turbine blade to a turbine wheel, said method comprising the steps of:
applying a first corrosion-resistant protective coating of MCrAlY to the bottom surface of the platform; and
applying a second corrosion-resistant protective coating of MCrAlY to the airfoil, the top surface, and the peripheral sidewall of the platform.

21. A method of coating a turbine blade according to claim 20, further comprising the step of using the same compound as the first protective coating and the second protective coating.

22. A method of coating a turbine blade according to claim 21, further comprising the step of using CoCrAlY as the first and second protective coatings.

23. A method of coating a turbine blade according to claim 22, further comprising the step of applying the second protective coating after the first protective coating is applied.

24. A method of coating a turbine blade according to claim 22, further comprising the step of masking off portions of the turbine blade except for the bottom surface of the platform, and applying the first protective coating using a high-velocity oxygenated fuel process.

25. A method of coating a turbine blade according to claim 22, further comprising the step of masking off portions of the turbine blade except for the airfoil, the top surface, and the peripheral sidewall of the platform, and applying the second protective coating using an electron beam vapor physical vapor deposition process

26. A turbine wheel comprising:
a rotatable disc having an outer periphery;
a plurality of turbine blades affixed to said disc at said outer periphery, each turbine blade comprising:
a platform having a top surface, a bottom surface and at least one peripheral sidewall;
an airfoil protruding from said top surface of said platform;
a blade mount extending from said bottom surface of said platform for attaching the turbine blade to said disc; and
a corrosion resistant protective coating of MCrAlY on said airfoil, said top surface, said peripheral sidewall and said bottom surface of said platform.

27. A turbine wheel according to claim 26, wherein said protective coating is CoCrAlY.
